(19) United States
(12) Patent Application Publication
(10) Pub. No.: US 2005/0275816 A1
(43) Pub. Date: Dec. 15, 2005

(54) Exposure apparatus

(75) Inventor: Hong Goo Lee, Gyeonggi-do (KR)

Correspondence Address: HELLER EHRMAN WHITE & MCAULIFFE LLP, 1717 RHODE ISLAND AVE, NW, WASHINGTON, DC, 20036-3001, US

(73) Assignee: Hynix Semiconductor Inc., Gyeonggi-do (KR)

(21) Appl. No.: 10/998,973

(22) Filed: Nov. 30, 2004

(30) Foreign Application Priority Data
Jun. 11, 2004 (KR) 10-2004-0043004

(51) Int. Cl. G03B 27/52

(52) U.S. Cl. 355/30; 355/75; 250/222.2

(57) ABSTRACT

An exposure apparatus is disclosed, the exposure apparatus for use with non-pellicle reticle including a sensing unit for detecting a particle at a reticle stage and a cleaner for cleaning the detected particle at the reticle stage.

### BACKGROUND OF THE INVENTION

1. Field of the Invention

The present invention generally relates to an exposure apparatus, and more specifically, to an exposure apparatus wherein a non-pellicle reticle is used to improve the throughput of the lithography process.

2. Description of the Prior Art

Currently, KrF laser is used as a light source in a lithography process. The KrF laser cannot be used to form a pattern having a width less than 100 nm due to its limitation.

Therefore, a new light source suitable for forming a fine pattern is needed as the integration density of semiconductor device is increased. An ArF laser having a wavelength of 193 nm and F2 laser having a wavelength of 157 nm are highly expected to be next generation light sources.

However, since absorbances of these new light sources by a pellicle are greater than that of the KrF laser, the throughput of the lithography process is decreased. Here, the pellicle refers to an organic membrane supported by a frame on the top of a reticle, which is used for preventing a contamination of the reticle.

In addition, the pellicle is deteriorated by swelling generated due to the absorption of laser by a pellicle, and its life span is reduced.

In general, a pellicle is required to have the following characteristics:
1. The transmission ratio of light must be sufficiently large.
2. The thickness must be less than 1 μm to minimize transmission interference, and the life span thereof must be sufficiently long.
3. The loss of light to laser must be minimized.
4. Mechanical elasticity must be large enough.
5. Lens contamination by pellicle vaporization must be minimal.
6. Must have a uniform structure in order to have a uniform transmission ratio.

FIG. 1 is a top-view illustrating a pellicle 13 supported by a frame attached to a reticle 11.

The pellicle generally consists of a polymer containing fluorocarbon. The pellicle provides stability for a light source having a wavelength of 248 nm.

While the pellicle provides a thermal and chemical stability for use with the KrF laser having a wavelength of 248 nm, it becomes unstable when used with ArF laser having a wavelength 193 nm and F2 laser having a wavelength 157 nm. That is, in the lithography process using ArF or F2 laser as a light source, the polymer containing fluorocarbon is deteriorated and becomes a lens contamination source.

Table 1 shows average bonding energies between elements.

TABLE 1

| | H | C | N | O | F |
|---|---|---|---|---|---|
| H | 104 | 99 | 93 | 111 | 135 |
| | (275.0) | (288.9) | (307.5) | (257.7) | (211.9) |
| C | | 83 a | 73 b | 86 c | ^{116 d} |
| | | (344.6) | (391.8) | (332.6) | (246.6) |
| N | | | 39 | 53 c | 65 |
| | | | (733.3) | (539.6) | (440.0) |
| O | | | | 47 | 45 |
| | | | | (608.5) | (635.6) |
| F | | | | | 37 |
| | | | | | (773.0) |

a: C = C 146 Kcal/mole, C≡C 200 Kcal/mole
b: C = N 147 Kcal/mole, C≡N 213 Kcal/mole
c: C = O 176(Aldehyde) Kcal/mole, 176(Keton) Kcal/mole
d: in CF₄

Table 2 shows light energies according to wavelengths.

TABLE 2

| Wavelength (nm) | Energy (Kcal/mole) |
|---|---|
| 436 | 65.6 |
| 365 | 78.4 |
| 248 | 115.3 |
| 193 | 148.2 |
| 157 | 182.2 |

Referring to Tables 1 and 2, the bonding energy of C and F is 116 Kcal/mole, and a light energy of the KrF laser having a wavelength of 248 nm is 115.3 Kcal/mole. As a result, the KrF laser has a thermal and chemical stability over a fluorocarbon material.

On the other hand, light energies of the ArF laser having a wavelength of 193 nm and F2 laser having a wavelength of 157 nm are 148.2 Kcal/mole and 182.2 Kcal/mole respectively. Since the light energies of these lasers are greater than the bonding energy of a fluorocarbon material, the absorption by the pellicle is increased.

Accordingly, the throughput of the lithography process in an exposure apparatus using the pellicle is reduced due to the absorption of the light by the pellicle.

In addition, particles are adsorbed to the surface of a reticle during the conveying and loading of the reticle of the exposure apparatus, thereby increasing mask error factor (hereinafter referred to “MEF”), which is an error generated by the particle. Due to the shrinkage of the pattern size due to high integration of semiconductor devices, the effect of MEF is increased.

### SUMMARY OF THE INVENTION

Accordingly, it is an object of the present invention to provide an exposure apparatus wherein a sensing unit for detecting a particle in a reticle stage of the exposure apparatus and a cleaner for cleaning the detected particle are employed to improve the reliability of the lithography process.

In order to achieve above-described object, there is provided an exposure apparatus for use with non-pellicle reticle, the exposure apparatus comprising:
a sensing unit for detecting a particle at a reticle stage; and
a cleaner for cleaning the detected particle at the reticle stage.

### BRIEF DESCRIPTION OF THE DRAWINGS

FIG. 1 is a top-view illustrating a pellicle 13 supported by a frame attached to a reticle 11.

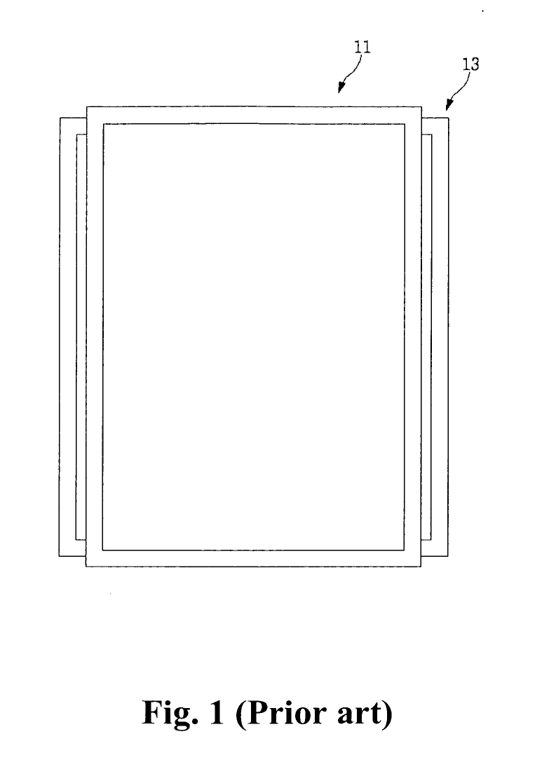

Table 1 shows average bonding energies between elements.

Table 2 shows a light energy according to wavelengths.

### DETAILED DESCRIPTION OF THE PREFERRED EMBODIMENTS

An exposure apparatus in accordance with a preferred embodiment of the present invention will now be described in detail. Wherever possible, the same reference numerals will be used throughout the drawings to refer to the same or like parts.

The main object of present invention is to maintain the throughput of the lithography process by preventing the contamination by particles generated transporting and loading of a reticle to the exposure apparatus during the exposing process.

In order to the object, an exposure apparatus employing a non-pellicle exposure mask is introduced.

The exposure apparatus of the present invention comprises a sensing unit for detecting particles in a reticle stage of an exposure apparatus and a cleaner for cleaning the detected particles in the sensing unit. The sensing unit and the cleaner effectively detect and remove particles even though a pellicle is not used.

The sensing unit comprises a sensor or a scanner. Preferably, the sensing unit may be a scanner such as a KLA particle detector.

The particles generated by the reticle itself and during the transport thereof are cleaned via the cleaner. The cleaner may further comprise an exhauster to exhaust the particles to outside of the exposure apparatus.

The ArF laser having a wavelength of 193 nm and F2 laser having a wavelength of 157 nm may be used as light sources in the exposure apparatus of the present invention although a pellicle is not used.

As described above, the exposure apparatus in accordance with the present invention maintains the throughput of the lithography process by allowing the use of non-pellicle exposure mask. The reticle contamination by particles during the transporting and loading stage of the reticle to the exposure apparatus can be prevented by detecting particles by a sensing unit and cleaning the detected particles by a cleaner. The detecting and cleaning process of particles secures the process margin in the lithography process of a semiconductor device and improves the reliability of the device.

As the present invention may be embodied in several forms without departing from the spirit or scope thereof, it should also be understood that the above-described embodiments are not limited by any of the details of the foregoing description. Rather the present invention should be construed broadly as defined in the appended claims. All changes and modifications that fall within the metes and bounds of the claims, or equivalences of such metes and bounds are intended to be embraced by the appended claims.

1. An exposure apparatus for use with non-pellicle reticle, the exposure apparatus comprising:
a sensing unit for detecting a particle at a reticle stage; and
a cleaner for cleaning the detected particle at the reticle stage.

2. The method according to claim 1, wherein the sensing unit comprises a sensor or a scanner.
